(19) United States
(12) Patent Application Publication
(10) Pub. No.: US 2015/0244968 A1
(43) Pub. Date: Aug. 27, 2015

(54) PROJECTION DEVICE AND COMPUTER READABLE MEDIUM

(71) Applicant: CASIO COMPUTER CO., LTD., Tokyo (JP)

(72) Inventor: Taiga MURAYAMA, Tokyo (JP)

(73) Assignee: CASIO COMPUTER CO., LTD., Tokyo (JP)

(21) Appl. No.: 14/626,797

(22) Filed: Feb. 19, 2015

(30) Foreign Application Priority Data
Feb. 25, 2014 (JP) 2014-034402

(51) Int. Cl. H04N 5/74

(52) U.S. Cl. CPC H04N 5/7475

(57) ABSTRACT

Provided is an input unit that receives an image signal; a projection system to that forms an optical image corresponding to the image signal received by the input unit and causes said optical image to be projected on an object via a projection lens unit, the optical image being formed by a micromirror device having a plurality of micromirrors; an optical sensor unit that detects, via the projection lens unit and the micromirror device, external light for a point command superimposed on the object; and a CPU that recognizes a location where the point command occurred on the object in accordance with the external light detected by the optical sensor unit.

### BACKGROUND OF THE INVENTION

1. Technical Field

The present invention relates to a projection device and a computer readable medium.

2. Background Art

It is common to use pointing devices to point to any location on an image projected from a projection device. Patent Document 1, for example, discloses a technique whereby a pointing device for use with a projection device has an indicator that emits ultrasonic signals, and ultrasonic wave reception units for receiving the ultrasonic waves emitted by the indicator are provided at three locations. With this technique, the amount of change in each signal received by the ultrasonic wave reception units is calculated to control the location of the pointer.

### RELATED ART DOCUMENT

### Patent Document

Patent Document 1: Japanese Patent Application Laid-Open Publication No. 2002-207566

### SUMMARY OF THE INVENTION

There have been many suggestions for techniques using pointing devices that are specialized for use with projection devices, including the technique described in the Patent Document above. On the other hand, all of the commonly-known laser pointers can point to any location on or off the projected image, but cannot be used for anything else.

The present invention was made in view of the above situation and aims at providing a projection device whereby it is possible to both point to projected images using a normal laser pointer and for the projection device function effectively during projection operation. The present invention also aims at providing a method of projection and a program.

Additional or separate features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, in one aspect, the present disclosure provides a projection device, including: an image input unit that receives an image signal; a projection unit including a projection optical system and a display element having a plurality of micromirrors, the display element forming an optical image corresponding to the image signal received by the image input unit and the projection optical system causing the optical image to be projected on an object; a detection unit that detects, via the projection optical system and the display element, external light for a point command superimposed on the object; and a recognition unit that recognizes a location where the point command occurred on the object in accordance with the external light detected by the detection unit.

In another aspect, the present disclosure provides a computer readable non-transitory storage medium that stores instructions executable by a computer having a device equipped with an image input unit that receives an image signal and a projection unit including a projection optical system and a display element having a plurality of micromirrors, the display element forming an optical image corresponding to the image signal received by the image input unit and the projection optical system causing the optical image to be projected on an object, the instructions causing the computer to perform: detecting, via the projection optical system and the display element, external light for a point command superimposed on the object; and recognizing a location where the point command occurred on the object in accordance with the external light detected by the detection unit.

In one aspect, the present invention makes it possible to not only point to projected images using a normal laser pointer, but also allows for effective functioning during projection operation.

It is to be understood that both the foregoing general description and the following detailed description are exemplary and explanatory, and are intended to provide further explanation of the invention as claimed.

### BRIEF DESCRIPTION OF THE DRAWINGS

FIG. 1 is an operation environment of a projection system that uses a projector according to one aspect of the present invention.

FIG. 2 is a functional block view of a schematic configuration of an electric circuit, which is the primary configuration of the projector of the same aspect as above.

FIG. 3 is a view of a configuration of a projection optical system and optical sensor unit from a micro-mirror element to a projector lens unit of the same aspect of above.

FIG. 4 is a field configuration of image frames during color image projection and lighting timing of the respective color light sources according to the same aspect as above.

FIG. 5 is a flowchart detailing the detection process for point location of a laser pointer according to the same aspect as above.

FIG. 6 is a flow chart detailing a sub-routine of a click operation process in FIG. 5 according to the same aspect as above.

FIG. 7 is a timing chart illustratively showing patterns for operation switches during click operations according to the same aspect as above.

### DETAILED DESCRIPTION OF EMBODIMENTS

An aspect of the present invention will be described below, with reference to drawings, in which a personal computer (hereinafter, “PC”) is connected to a DLP (registered trademark) projector to form a projection system.

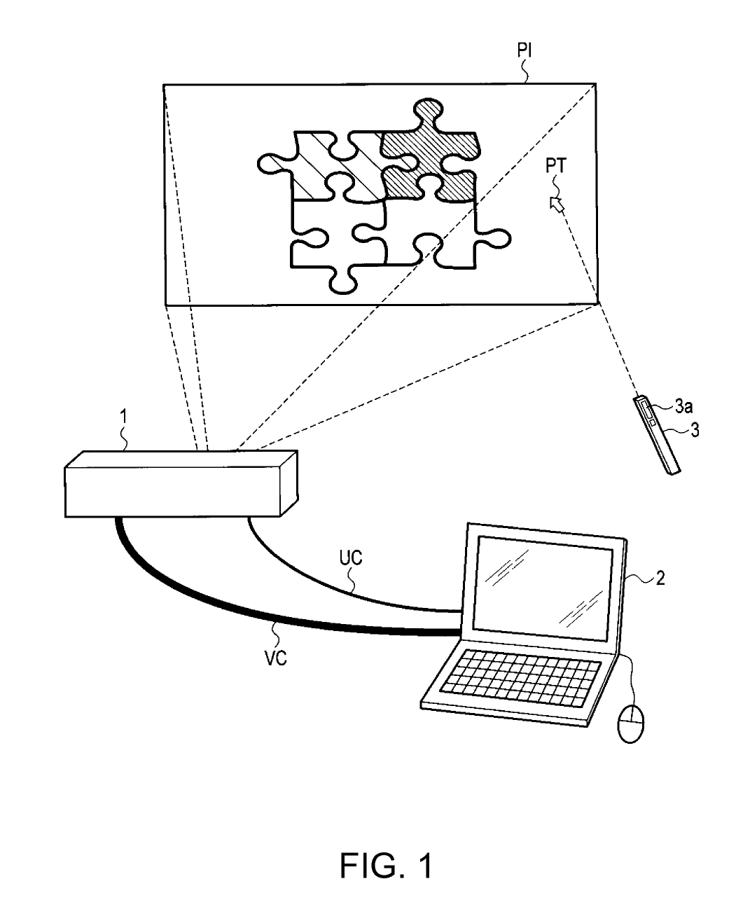

FIG. 1 illustratively shows a connection configuration of a projection system according to the present embodiment. In FIG. 1, reference character 1 is a projector, and reference character 2 is a PC that provides images to be projected to the projector 1. The projector 1 and the PC 2 are connected to each other by a VGA cable VC and a USB cable UC. The PC 2 provides image signals via the VGA cable VC, and the projector 1 projects a projected image PI corresponding to these image signals onto a screen as needed.

Reference character 3 is an ordinary laser pointer. This laser pointer 3 has an operation switch 3a on one end of the pen-shaped shaft thereof, and can control the ON/OFF operation of laser output, for example. Holding down the operation switch 3a makes it possible to emit a point mark PT shaped beam of light and to superimpose this point mark on and off the projected image PI, for example.

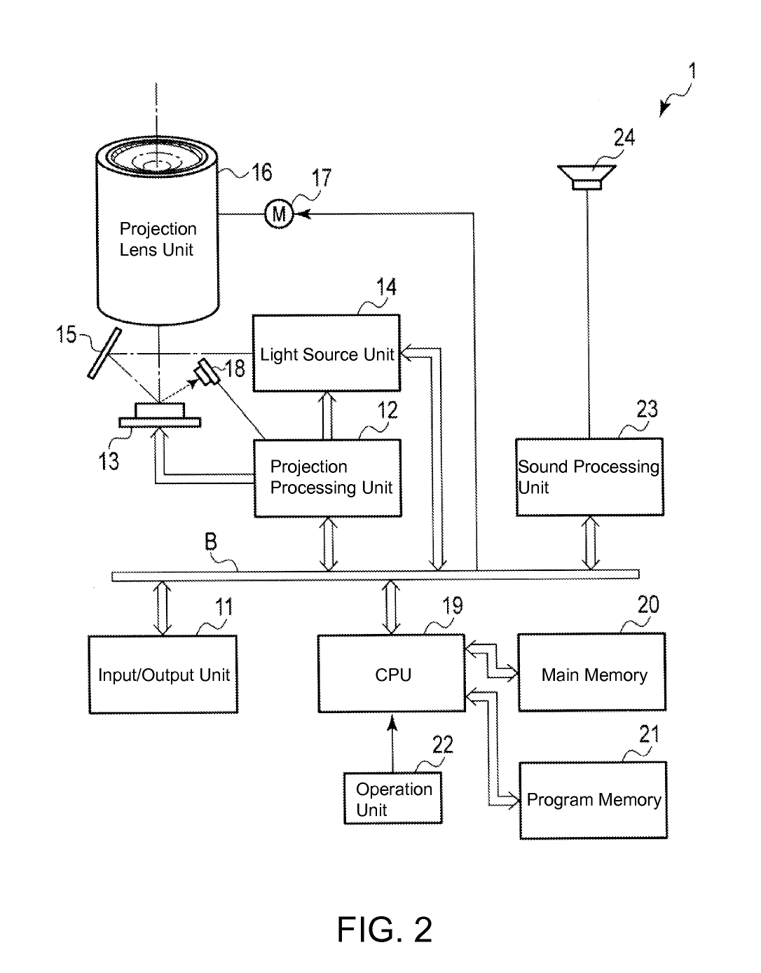

FIG. 2 is a functional block view of a schematic configuration of an electric circuit, which is the primary configuration of the projector 1 described above.

An input unit 11 is a video input terminal, RGB input terminal, VGA terminal, a USB terminal for connecting to the PC 2, or the like, for example. The image signals inputted to the input terminal 11 are digitalized as necessary and then sent to a projection processing unit 12 through a bus B.

The projecting processing unit 12 converts the image data to be inputted into an appropriate format for projection, and drives a micromirror device 13, which is a display element, through high speed time division driving in accordance with a product of a prescribed frame rate, such as 120 frames/second, a division number of color components, and a display gradation number, for example.

This micromirror device 13 forms optical images by the light reflected from a plurality of arrayed WXGA (wide eXtended graphic arrays) (1280w×800h pixels) micromirrors, for example, the angles of which are changed by individually turning the micromirrors ON/OFF at high speed, thereby displaying an image.

Meanwhile, the primary colors R (red), G (green), and B (blue) are sequentially emitted by time division from a light source unit 14. The light from this light source unit 14 is totally reflected by the mirror 15 and is then incident on the micromirror device 13.

The light reflected by the micromirror device 13 forms an optical image corresponding to the color of the light from the light source, and this optical image is projected onto a screen (not shown) serving as the projection target via a projection lens unit 16.

The light source unit 14 has three types of semiconductor light-emitting devices that respectively emit R, G, and B, for example, such as an LED (light-emitting diode) or LD (laser diode). The light source unit 13 also emits W (white) light by causing all three types of these semiconductor light-emitting devices to emit light at the same time. The light source unit 14 can allow black-and-white images to be projected from the projection lens unit 16.

The projection lens unit 16 includes a zoom lens for varying the projection angle and a focus lens for varying the focusing position. A position along the optical axis of these lenses can be moved by a rotating circuit of a lens motor (M) 17. The lens motor 17 drives the lens through control from a CPU 19 (described later) via the bus B.

An optical sensor unit 18 is provided on the side of the micromirrors of the micromirror device 13, which correspond to individual pixels, and reflected light (hereinafter, “OFF light”) is emitted towards this side in a state (OFF state) in which the light that is reflected by the mirror 15 is not reflected towards the projection lens unit 16.

This optical sensor unit 18 is placed in a position so as to be able to receive all light reflected by the individual micromirrors in the OFF state when light from the screen direction, which will pass through the projection optical path via the projection lens unit 16, is incident on the micromirror device 13. A detection signal indicating this reception of reflected light is sent to the CPU 19 (described later) via the above-mentioned projection process 12.

The CPU 19 controls all operations of every circuit. The CPU 19 is directly connected to a main memory 20 and a program memory 21. The main memory 20 is an SRAM, for example, and functions as a work memory of the CPU 19. The program memory 21 is an electrically rewritable non-volatile memory that stores operation programs for execution by the CPU 19, various types of routine data, and the like. The CPU 19 uses the main memory 20 and the program memory 21 to collectively execute control operation inside the projector 1.

The CPU 19 runs various types of projection operations in accordance with key operation signals from the operation unit 22. The operation unit 22 includes a key operation unit provided on the body of the projector 1, and an infrared light receiving unit that receives infrared light from a specialized remote controller (not shown) for the projector 1. Key operation signals corresponding to user operation of the key operation unit on the body of the projector or the remote controller are directly outputted to the CPU 19.

The CPU 19 is also connected to a sound processing unit 23 via the bus B. The sound processing unit 23 has a sound source circuit, such as a PCM sound source, and converts sound data to be used during projection operation into analog form, drives a speaker unit 24 to amplify sound, emits a beep sound as necessary, and the like.

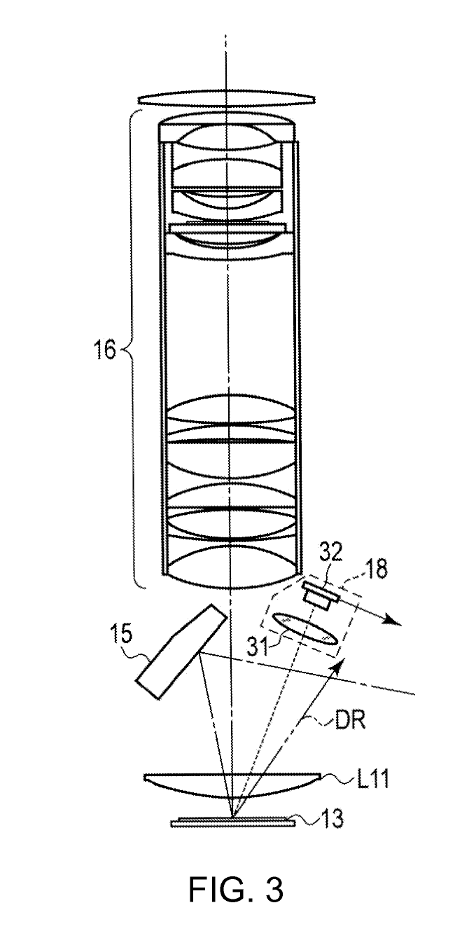

Next, a more specific configuration of the optical sensor unit 18 will be described with reference to FIG. 3.

FIG. 3 shows a part of the projection optical system, from the micromirror device 13 to the projection lens unit 16. Light from the light source unit 14 is totally reflected by the mirror 15 and is then incident on the micromirror device 13 via a lens L11. At this time, the projection processing unit 12 drives the individual micromirrors constituting the micromirror device 13 to either an ON or OFF angle. Light that is reflected by the micromirrors in the ON state forms an optical image, which is transmitted towards the screen, i.e., the object to be projected on, through the projection lens unit 16 via the lens L11.

Meanwhile, OFF light DR, which is light reflected by the micromirrors in the OFF state, goes through the lens L11 and does not reach the projection lens unit 16, but rather is incident on an area (not shown) coated with anti-reflection coating and ultimately converted into thermal energy.

In the projection environment shown in FIG. 1, however, the focus lens of the projection lens unit 16 causes the projected image PI to be accurately focused on the screen, i.e., the object to be projected on. When this focusing occurs, if the laser pointer 3 projects the point mark PT of the laser on any position within the projected image PI, the light of the laser light reflected by the screen travels through the projection optical route of the projection lens unit 16 and becomes incident on the micromirror device 13.

At this time, if the respective micromirrors constituting the micromirror device 13 are in the OFF state, the optical sensor unit 18 is disposed such that all laser light reflected by the respective micromirrors can be received. The optical sensor unit 18 is positioned in a direction corresponding to the OFF light DR and has a configuration whereby light beams condensed by a condenser lens 31 are received by an area sensor, or more specifically, a CMOS area sensor 32, for example.

Accordingly, pixel locations of the highest reception level are identified, thereby allowing for identification of coordinate locations where the point mark PT from the laser pointer 3 is superimposed on the projected image PI on the object to be projected on.

When the respective micromirrors of the micromirror device 13 are in the ON state, the reflected light of the laser light from the laser pointer 3 that has traveled through the projection lens unit 16 is reflected by the respective micromirrors towards the optical path direction from the light source unit 14, or specifically, towards the mirror 15.

Next, the operation of the above-mentioned embodiment will be described.

In the projection environment shown in FIG. 1 of the present embodiment, when the point mark PT from the laser pointer 3 is superimposed on the projected image PI, the PC 2 relates this to the image data projected at this time and chronologically stores position coordinates of the point mark PT.

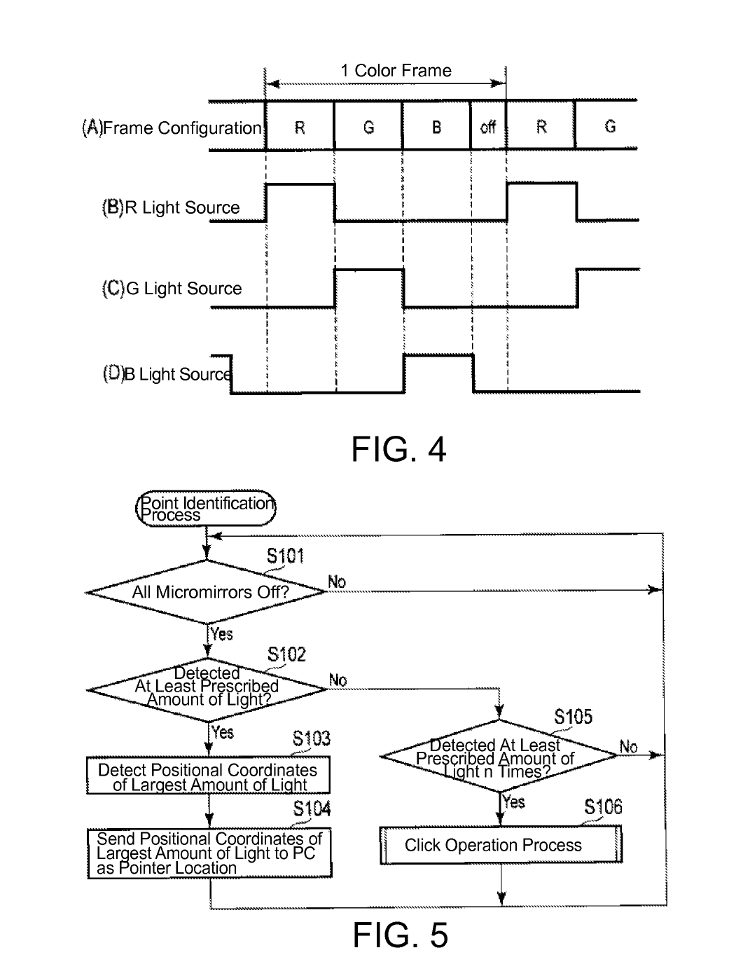

FIG. 4 is a field configuration of image frames during color image projection according to the present embodiment.

As shown in FIG. 4(A), one color image frame, which corresponds to 1/120th of a second, for example, is constituted of a R (red color image) field, G (green color image) field, B (blue color image field), and an off field.

As shown in FIG. 4(A), the off field is set to have a shorter period than the R field, G field, and B field in order to avoid, as much as possible, the projected image becoming darker due to temporary stopping of the projection.

As shown in FIGS. 4(B) to (D), the respective light sources of R, G, and B inside the light source unit 14 are turned on and driven through time division in accordance with the R field, G field, and B field.

Meanwhile, in the off field at the end of the frame, the respective light sources of R, G, and B in the light source nit 14 are turned off, at which time the projection processing unit 12 causes all of the micromirrors of the micromirror device 13 to go into the OFF state.

Therefore, in accordance with the output from the optical sensor unit 18 during the off field, it is possible for the CPU 19 to identify, via the projection processing unit 12, on which coordinate locations the point mark PT from the laser pointer 3 is superimposed on the projected image PI when all of the micromirrors go into the OFF state.

FIG. 5 shows the contents of a process run by the CPU 19 to recognize the location of the point mark PT of the laser pointer 3. The CPU 19 runs this process alongside projection operation. This process is run by the CPU 19 for each off field, and the CPU 19 stores the results of this process in the main memory 20.

At the beginning of the process, the CPU 19 waits for the frame described above to become the off field by repeatedly determining if all the micromirrors of the micromirror device 13 are in an OFF state (step S101).

When the off field starts, the CPU 19 determines if there an area having at least a prescribed amount of light in accordance with output from the optical sensor unit 18 (step S102).

If the CPU 19 determines that there is an area having at least a prescribed amount of light, then at this time the CPU 19, in accordance with output from the optical sensor unit 18, detects the coordinates having the highest level of reception, which are interpreted as the point mark PT of the laser pointer 3 on the projected image PI (step S103).

The CPU 19 sends the detected location coordinates to the PC 2 as correctable locations, and also sends thereto frame number data, or namely, serial number information indicating the number of frames in which the image data has been linked and projected. The CPU 19 also causes the correctable locations and frame number data to be recorded (step S104).

Thereafter, the CPU 19 returns to the process in step S101 to await the off field of the next image frame.

In step S102, if the CPU determines that there is no area having at least a prescribed amount of light in accordance with the output from the optical sensor unit 18, the CPU 19 next determines if click operation by the laser pointer 3 has occurred by detecting if at least a prescribed amount of light has been detected in accordance with output from the optical sensor unit 18 within the immediately preceding n frames (where n is a natural number of at least 2), such as 12 frames (equivalent to 0.1 seconds at 120 frames/second), for example (step S105). The click operation will be described in detail later.

If the CPU 19 does not detect at least a prescribed amount of light in the immediately preceding n frames in accordance with output from the optical sensor unit 18, and if the CPU 19 has determined that click operation of the laser pointer 3 has not occurred, then the CPU 19 returns to the process in step S101 to await the off field of the next image frame.

In step S105, if the CPU 19 detects at least a prescribed amount of light in the immediately preceding n frames in accordance with output from the optical sensor unit 18 and determines that a click operation of the laser pointer 3 has been performed, then the CPU 19 identifies what type of click operation has occurred, and executes functions that correspond to these identification results (step S106), after which the CPU 19 returns to the process in step S101 to await the off field in the next image frame.

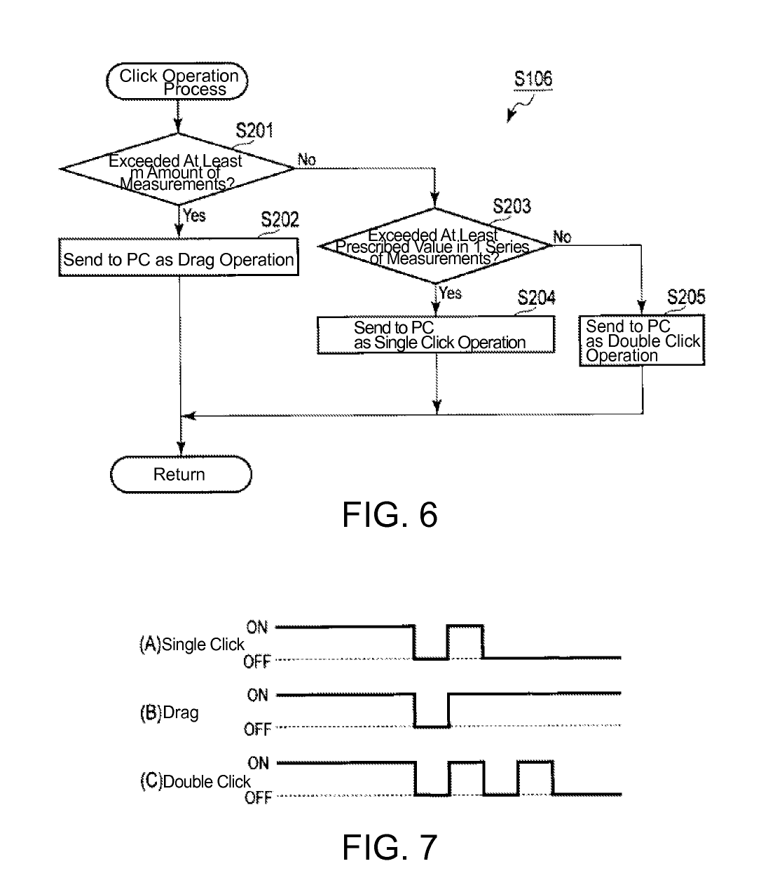

FIG. 6 is a flow chart showing detailed contents of a sub-routine of the click operation process of step S106 in FIG. 5.

In the present embodiment, there are three types of click operations: single click, double click, and triple click. Certain functional operations can be commanded in accordance with the respective click operations in a state in which image data for projection use is being outputted by the PC 2, such as next page, previous page, or movement of image elements on the page during document image projection using presentation software, for example.

In the process in FIG. 6, at the start of the process the CPU 19 determines if a plurality m (where m is a natural number of at least 2) of frames, such as 24 frames (equivalent to 0.2 seconds at 120 frames/second) having at least a prescribed amount of light have been consecutively detected in accordance with output from the optical sensor unit 18 (step S201).

When the CPU determines that the output of the optical sensor unit 18 is at least a prescribed amount of light continuing for at least m frames, then as shown in FIG. 7(B), the CPU 19 determines that the operation of the operation switch 3a of the laser pointer 3 was temporarily stopped and then consecutively pressed again, thereby being interpreted as the user of the laser pointer 3 performing a drag operation on the projected image PI. The CPU 19 sends identification data indicating that drag operation has been performed, and position coordinate data obtained during the drag operation to the PC 2 until drag operation, in which the output from the light sensor unit 18 is at least a prescribed amount of light, ends (step S202). When the CPU 19 no longer detects that the output from the optical sensor unit 18 is a prescribed amount of light, the sub-routine in FIG. 6 ends.

In step S201, when the CPU 19 detects that the output from the optical sensor unit 18 is not at least a prescribed amount of light continuing for at least m frames, the CPU 19 then determines, in only a series of measurements, whether the output from the optical sensor unit 18 is at least a prescribed amount of light (step S203).

If the CPU determines that the output from the optical sensor unit 18 is at least a prescribed amount of light in only a series of measurements, then as shown in FIG. 7(A), the CPU interprets this as that the user has temporarily stopped operation of the operation switch 3a of the laser pointer 3; that the operation switch 3a is being pressed in only a series of measurements; and that the user of the laser pointer 3 is performing a single click operation on the projected image PI. In response to this, the CPU 19 transmits identification data indicating that a single click operation has been performed to the PC 2 (step S204), and then ends the sub-routine in FIG. 6.

In step S203, if the CPU determines that the output from the optical sensor unit 18 is not at least a prescribed amount of light in only a series of measurements, then as shown in FIG. 7(C), the CPU interprets this as that the user has temporarily stopped operation of the operation switch 3a of the laser pointer 3; that the operation switch 3a is being pressed in only a series of measurements; that the usage of the operation switch 3a and the series of push operations are consecutive; and that the user of the laser pointer 3 is performing a double click operation on the projected image PI. In response to this, the CPU 19 transmits identification data indicating that a double click operation has been performed to the PC 2 (step S205), and then ends the sub-routine in FIG. 6

In this manner, a large variety of click operations can be configured in accordance with the operation state of the operation switch 3a and used for functional operations during image projection.

As described above, the present embodiment makes it possible not only to perform point commands on a projected image by using a normal laser pointer 3 that is not specialized for use with the projector 1, but also to perform effective functional operations during projection.

Furthermore, in the embodiment described above, the optical sensor 18, which has an area sensor, detects when the light reflected from the object to be projected on (e.g., a screen) travels through the projection optical path and is incident on the micromirror device 13; thus, it is possible to accurately detect, with a simple configuration, where a point command has taken place.

In the embodiment described above, the blinking pattern of the point mark PT caused by operation of the operation switch 3a of the laser pointer 3 is recognized as a prescribed functional operation; therefore, simple operation using the normal laser pointer 3 allows for a large variety of functions for presentations and the like.

In the embodiment described above, an off field in which image projection is not performed is provided, and the position where the point mark PT of the laser pointer 3 is superimposed on the projected image PI is detected; thus, it is possible to detect the precise location coordinates without affecting the projected image.

Although not explained in the embodiment described above, it is possible to detect the position where the point mark PT of the laser pointer 3 is superimposed on the projected image PI without providing a period where image projection is not performed, as in the off field, and without lowering the brightness of the projected image. This is accomplished by calculating the difference between the detected output of the optical sensor 18 and the images projected by the micromirror device 13 by the projection processing unit 12.

In addition, it is also possible to realize projection operation without providing a period in which projection is not performed on the entire screen and in which brightness and image quality of the projected image is not reduced, while maintaining high detection precision of the optical sensor 18. This is accomplished by dividing, during projection of a red color image in the R field, for example, areas into a checkered pattern and categorizing these into areas in which image projection is performed and areas in which image projection is not performed, and then performing detection with the optical sensor unit 18 while inversing the projection/non-projection state in these areas.

The above-mentioned embodiment described an example in which the light source unit 14 had semiconductor light-emitting devices that emit primary colors, but the present invention is not limited to this, and is similarly applicable even if using a more general DLP (registered trademark) projector that has a high pressure mercury lamp and a color wheel, for example.

The present invention is not limited to the embodiments described above, and various modifications can be made without departing from the scope thereof. The functions in the embodiments described above may be implemented by being combined together as suitably as possible. Various types of stages can be included in the embodiments described above, and the various types of inventions can be extracted by appropriate combination of the disclosed plurality of configuration requirements. Even if several configuration requirements are removed from the total configuration requirements described in the respective embodiments, this configuration from which these configuration requirements have been removed can be extracted as an invention as long as the effects are able to be obtained.

What is claimed is:

1. A projection device, comprising:
an image input unit that receives an image signal;
a projection unit including a projection optical system and a display element having a plurality of micromirrors, said display element forming an optical image corresponding to the image signal received by the image input unit and said projection optical system causing said optical image to be projected on an object;
a detection unit that detects, via the projection optical system and the display element, external light for a point command superimposed on said object; and
a recognition unit that recognizes a location where the point command occurred on the object in accordance with the external light detected by the detection unit.

2. The projection device according to claim 1, wherein the detection unit includes an area sensor that receives the external light reflected by the plurality of micromirrors of the display element.

3. The projection device according to claim 1, wherein when the external light detected by the detection unit has a blinking pattern, the recognition unit recognizes a prescribed input operation therefrom.

4. The projection device according to claim 1, wherein the detection unit performs detection during an off field in which image projection is not performed by the projection unit.

5. The projection device according to claim 1,
wherein the projection unit inverts areas where image projection is performed by the display element and areas where image projection is not performed, said inversion being performed through time division, and
wherein the detection unit performs detection for areas when image projection is not performed by the projection unit with respect to said areas.

6. A computer readable non-transitory storage medium that stores instructions executable by a computer having a device equipped with an image input unit that receives an image signal and a projection unit including a projection optical system and a display element having a plurality of micromirrors, said display element forming an optical image corresponding to the image signal received by the image input unit and said projection optical system causing said optical image to be projected on an object, the instructions causing the computer to perform:
detecting, via the projection optical system and the display element, external light for a point command superimposed on said object; and
recognizing a location where the point command occurred on the object in accordance with the external light detected by the detection unit.
